(19) United States
(12) Patent Application Publication
(10) Pub. No.: US 2008/0286734 A1
(43) Pub. Date: Nov. 20, 2008

(54) Method and Device For Image Quality Accreditation, Hands on Cme, and For Control and Analysis of Accreditation at the Enterprise Level

(76) Inventor: Shraga Rottem, Forest Hills, NY (US)

Correspondence Address: HUNTON & WILLIAMS/NEW YORK;INTELLECTUAL PROPERTY DEPT., 1900 K STREET, N.W., SUITE 1200, WASHINGTON, DC, 20006-1109, US

(21) Appl. No.: 11/995,784

(22) PCT Filed: Jul. 20, 2006
(86) PCT No.: PCT/US06/28241

§ 371 Date: Jul. 15, 2008

Related U.S. Application Data
(60) Provisional application No. 60/701,321, filed on Jul. 20, 2005.

(51) Int. Cl. G09B 23/28; G06K 9/00

(52) U.S. Cl. 434/262; 382/128

(57) ABSTRACT

A method and device for accreditation of a user on an imaging device is described. The method and device can also be used for providing electronic hands-on continuing medical education credits/hours based on proficiency in generating high-quality images. In addition, other medical imaging devices, such as an ultrasound system—in which image quality is dependent on the user professional's ability—can be upgraded using the disclosed methods and devices, thereby allowing the system to automatically freeze an image if it is best-quality rated. Finally, the disclosed invention provides an analysis of accreditation at the enterprise level.

### CROSS-REFERENCE TO RELATED APPLICATIONS

This application claims the benefit of provisional patent application U.S. Ser. No. 60/701,321 filed Jul. 20, 2005 by the present inventor. The contents of U.S. Ser. No. 60/701,321 are expressly incorporated herein by reference thereto.

The following references are hereby explicitly incorporated by reference thereto:
1. WIPO Publication WO/2004/057554, App No PCT/CA2003/001987, published Aug. 7, 2004 to Choquet.
2. Shraga Rottem, Method and system for enhancing the quality of device images, United States Patent Pending 20040122307, PCT priority date Mar. 8, 2001; Published Jun. 24, 2004;
3. Rottem S, Bronshtein M, Thaler I, Brandes J M, First trimester transvaginal sonographic diagnosis of fetal anomalies, Lancet. 1989; 1 (8635): 444-5.
4. Shraga Rottem, IRONFAN: new time-oriented malformation work-up and classification of fetal anomalies, Ultrasound in Obstetrics & Gynecology, 1997; 10; 373-74
5. Abdullah, S. C. & Cooley, R. E. (2000) Using constraints to develop and deliver adaptive tests in H. Cooper & S. Clowes, editors, Proceedings of the Fourth International Computer Assisted Assessment Conference, Loughborough University, UK; 93-101
6. Lil Valentin, High-quality gynecological ultrasound can be highly beneficial, but poor-quality gynecological ultrasound can do harm, Ultrasound in Obstetrics and Gynecology 2002; 13, 1, p. 1-7

### BACKGROUND OF THE INVENTION

### Field of Invention

The present invention relates to devices and methods for image quality accreditation, hands-on continuing medical education, and for control and analysis of accreditation at the enterprise level.

### BACKGROUND AND SUMMARY OF THE INVENTION

Ultrasound systems are currently used to rule out and diagnose a long list of diseases involving almost any organ in the body from the liver, kidneys, ovaries, thyroid, prostate, breasts, muscles, eyes, and even the fetus. In most countries, these machines are operated by qualified personnel such as sonographers, technicians, physicians belonging to various specialties, general practitioners, residents, nurses, physicians' assistants, and midwives. The licensing process in diagnostic ultrasound is based on graduation from technician and sonographer programs or from medical schools and may result in licensing as a registered diagnostic medical sonographer (“RDMS”).

More recently, HMOs in the USA have started to require ultrasound labs and private practices to be accredited by professional societies such as The American Institute of Ultrasound in Medicine (“AIUM”) and others as a precondition for billing and reimbursement privileges. These societies have also started to require labs to provide proof that they employ qualified personnel by, for example, the mailing of around fifty good quality sonograms (per specialty and per lab) as proof of the overall quality of service. Tests such as Nuchal Translucency (“NT”) or Nasal Bone (“NB”) measurement (a first trimester test used in the screening for Down's Syndrome) are not reimbursed to practitioners by HMOs until a sonologist has passed a test on NT/NB measurement and interpretation of results. This includes submission of a number of NT/NB images showing proper positioning of calipers on the nuchal or nasal scans.

Residents in specialties such as OB/GYN need to go through a four-week rotation in the ultrasound lab as part of their training program. At the conclusion of their specialization process, they will also start to perform and bill for sonograms (among other procedures) as independent professionals. American professional societies such as the American Registry for Diagnostic Medical Sonography (“ARDMS”) also require a minimal number of CME credits or hours per year for the maintenance of a person's license, as in the case of those licensed as a RDMS. These credits are achieved by attending medical conferences or by taking multiple choice tests after reading an article in a professional journal or reviewing an article posted at a websites, including websites of manufacturers of ultrasound systems.

In contrast to medical imaging procedures such as CT and MRI where the machine scans the body and generate images, in ultrasound the images are provided by the operator scanning the patient. Therefore, the quality of the sonograms is heavily dependent on the skill of the operator in moving the probe and calibrating the machine until a good quality image is achieved.

The current training, licensing, qualification, accreditation, and sonologists' annual certification renewal process in the Unites States is mostly based on graduation from certain programs and accumulation of CME credits based on attendance at professional conferences and on multiple choice tests. Very little of this process has to do with proof of the manual skills of a given professional in generating high quality sonograms. The achievement of a precise diagnosis of pathologies in an ultrasound depends on the ability of an individual to generate a high quality image. Many diagnostic errors in ultrasound could be avoided if the qualification of the operators could be based on the quality of their images as proof of proficiency rather than, for example, on accumulation of CME credits at conferences.

### DETAILED DESCRIPTION OF THE INVENTION

The first aspect of the invention described in this document is a method and process allowing a computerized device such as an ultrasound system to automatically certify an operator for the quality of the images he/she generates while scanning patients. For example, after scanning a gynecological case the sonographer releases a report made of text and images, which may state measurements and findings such as:
a) normal texture and size RT ovary measuring 2.5 cm×2 cm and normal LT ovary measuring 2.8×1.8 cm;
b) normal texture and size uterus measuring 8.7 cm×5.3 cm and endometrial thickness 0.3 cm;
c) normal cul-de-sac with minimal amount of free fluid.

Another example is the obstetrical area in which the Down's syndrome screening test is based. This first trimester test is an ultrasound measurement and reporting of NT and NB size inside time-oriented fetal nomograms. The report on said test also includes all the sonogram data as mentioned in a-c above and is stored in places such as a Picture Archiving Reporting and Communication System (“PACS”) or alternatively web-PACS, PCs, CD-ROMs, and sometimes on a storage board inside an ultrasound system.

According to the present invention, the images generated by an operator during routine scanning are automatically extracted from:
i) The data transmitted from the ultrasound system to other devices in the lab or to web based systems or from 3-D reconstruction of scans;
ii) A sonogram reporting system; or
iii) A patient file.

The extraction is done by word or term matching and extraction methods and is deposited in a personal image library of each operator performing ultrasound.

The second aspect of the invention is the personal password controlled folder for each operator and its activation by images from sources such as:
i) Routine scanning or a 3-D reconstruction process;
ii) By depositing images stored in media by the operator such as a CD-ROM, DVD, or via the web;
iii) An eye-hand web-based/hardware-based simulator device, which generates gold standard images in lieu of an ultrasound machine.

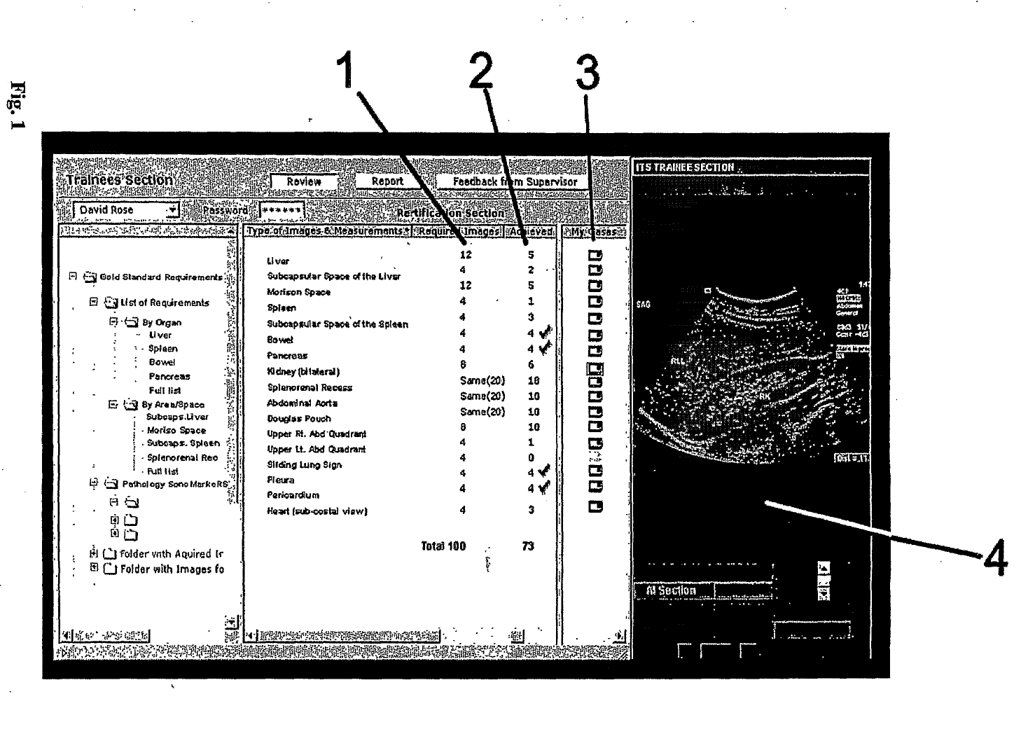

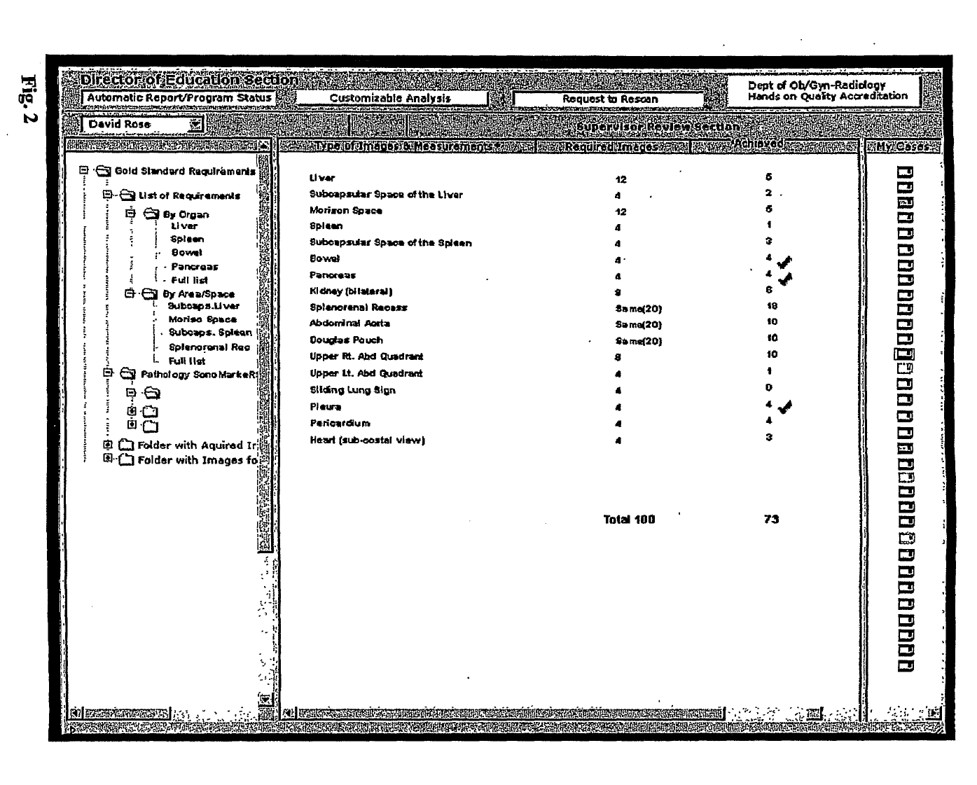

With respect to the figures, FIG. 1 is the “Trainee and Enterprise Access and Navigation” Screen. Reference numeral 1 is the enterprise requirements section. Reference numeral 2 is the real-time summary of the user's efforts. Reference numeral 3 indicates the user's images library before and after correction or acceptance by enterprise or automatic bouncing of low-quality images. Reference numeral 4 is the image review area including images with areas to improve as marked by the enterprise. FIG. 2 is the “Enterprise Review Section”.

FIG. 1 and FIG. 2 illustrate possible navigation inside this personal folder and a means of submission of a library with gold standards to a human reviewer or to a pattern recognition system for quality analysis and feedback until the operator achieves a full library satisfying the terms of the accreditation.

Thanks to this invention, all personnel scanning in a hospital or elsewhere can be certified for the quality of their sonograms in a seamless way by using their routine scanning procedures. This without need to attend courses, take exams, and submit images to be re-qualified. Once a month the system described in this invention could send personal statistics to all the ultrasound operators in a hospital and indicate what images are still missing in the personal library.

The third aspect of the invention is the manual (by operator) or automatic/machine based selection/freezing of digital media, e.g. real time sonograms or digitized training videos or images generated by a simulator, on frames pre-selected as ideal by the training and accreditation organization/society, i.e. hot matching frame(s). Thus, the automatic freezing of real time images from a patient on the gold standard frame could be done by the ultrasound system while scanning in lieu of the operator. This will secure constant high-quality images at all times. It will therefore lower the variability of scans and quality deterioration due to operator fatigue from routine, repetitive scanning or from inter-operator skill variability.

As part of this aspect of the invention, during manual freezing by an operator/trainee of digitized video or of images from the eye-hand simulator, the system will ask for labeling of key anatomic structures when frozen at the right time. The user/trainee can drag and place arrow(s), calipers, and label(s) on the correct structure and area, i.e. hot matching area(s). The device will accept or reject a given arrow, caliper, or label accordingly; for example, the calipers measuring NT or NB in First Trimester Down's Syndrome.

A further part of this aspect of the invention is the capability of an organization or association in charge of the accreditation process (or as part of the calibration of an ultrasound system) to tune the number of hot frames according to the desired quality to be reached by a beginner or by an advanced operator/trainee. By allowing several sequential hot frames, one can encompass gold standard quality images and near optimal quality material, therefore shortening training time while conserving the level of training. A more advanced level of training can be achieved when the gold standard is based on one frame only.

A fourth element of the invention is a method and server allowing for the overall control and analysis of the training and image-quality accreditation system at the enterprise/organizational level. Such an organization could be the DoD or a professional college such as the AMA or the ACOG.

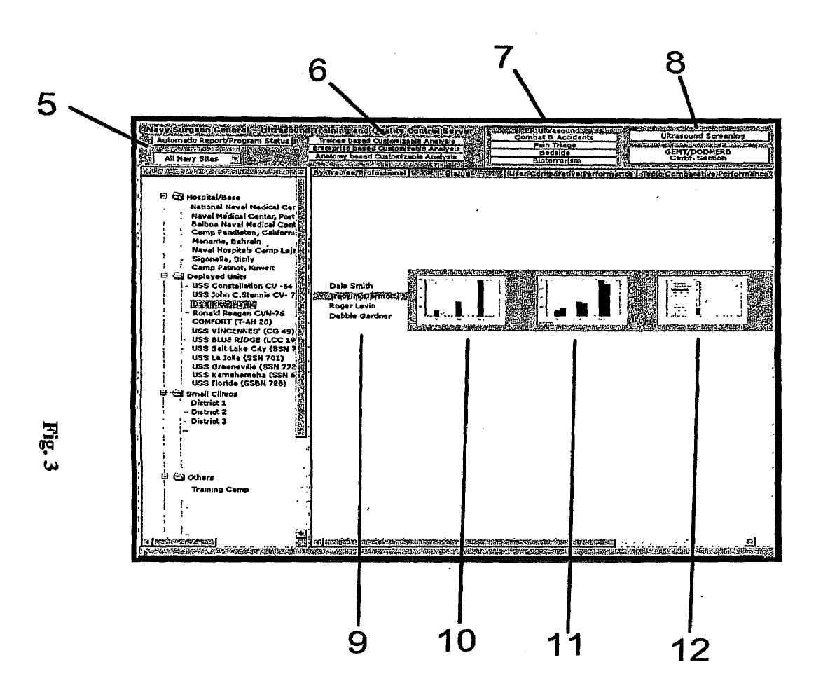

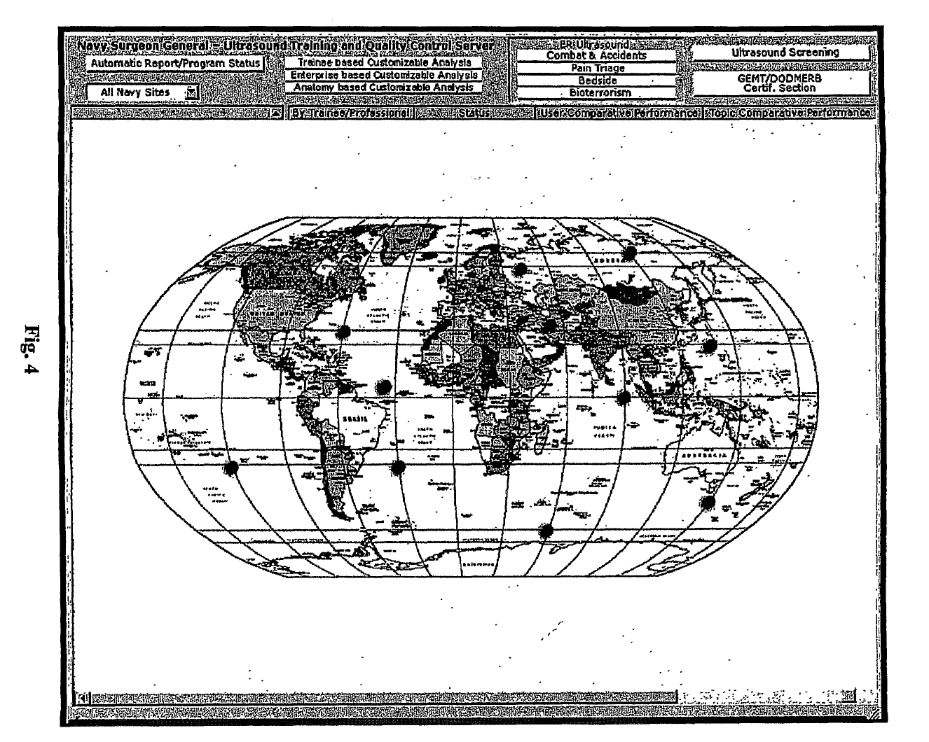

FIGS. 3 and 4 illustrate possible navigation means for controlling the training and the accreditation process. They also show analysis of possible problems of the process at the personal and item/image level in an organization such as the US Navy. In FIG. 3, reference numeral 5 is the all-sites section. Reference numeral 6 is the analytic section. Reference numeral 7 is the specialties area (diagnostic), whereas reference numeral 8 is the specialties area (screening). Also shown by reference numeral 9 is the users performance section. Reference numeral 10 is one's personal performance while reference numeral 11 is one's performance inside the enterprise. Finally, reference numeral 12 is the organ/area based comparative performance and alert system. FIG. 5 shows a “weighted alert system on users and training system performance using all available variables”.

A fifth aspect of this invention is a device and method for hands-on continuing medical education (“CME”) by the combination of elements described in this document. While this invention describes a device and method for use with ultrasound, it is contemplated that this device can be adjusted to any other medical or non-medical imaging procedure such as for endoscopy or boroscopy without departing from the original scope of the invention. The conventional CME process—based on attending courses, seminars, congresses, and the like and/or multiple choice test—provides proof of theoretical knowledge in an imaging specialty but does not prove a professional's competence to generate high quality images.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

1. A method for training and certifying an operator of a medical device comprising:
generating a report of an examination of an operator's performance on a device;
storing said report in a personal library for said operator;
compiling statistics for said operator's performance based on said report in said operator's personal library;

2. A method comprising:
providing an imaging instrument which selects, freezes, and records a best image or images of an organ or area on a person during acquisition of said image or images or during 3-D reconstruction, said selection based on a computerized selection of a best quality frame;
producing a recorded session comprising the records of some or all of said best images.

3. The method of claim 2, further comprising placing said recorded session onto an eye-hand simulator, and using said recorded session for training purposes where the trainee uses a virtual probe or scope and exercises the freeze function to gather the best quality frame or frames, to label key structures, and to perform until matching said computerized selection of claim 2.

4. A recorded session as described in claim 3, which is calibrated to the level of experience of the operator.

5. A method for the automatic analysis of the training and image quality accreditation system at the enterprise level comprising:
providing a device which
reports the per user and per area/organ progress towards accreditation, and reports on user, organ, or equipment related problems at an early stage.

6. The system of claim 1 further adapted to provide a hands-on CME process for proving the manual and hand and/or eye skills of a professional in generating high-quality images.

7. The system of claim 2 further adapted to provide a hands-on CME process for proving the manual and hand and/or eye skills of a professional in generating high-quality images.

8. The system of claim 3 further adapted to provide a hands-on CME process for proving the manual and hand and/or eye skills of a professional in generating high-quality images.

9. The system of claim 4 further adapted to provide a hands-on CME process for proving the manual and hand and/or eye skills of a professional in generating high-quality images.

10. The system of claim 5 further adapted to provide a hands-on CME process for proving the manual and hand and/or eye skills of a professional in generating high-quality images.
